(19) United States
(12) Patent Application Publication
(10) Pub. No.: US 2017/0203944 A1
(43) Pub. Date: Jul. 20, 2017

(54) PILFER-PROOF CAP CRIMPING TOOL

(71) Applicant: Masterlink Corporation, Minato-ku, Tokyo (JP)

(72) Inventor: Hiroshi FURUYA, Nirasaki-shi, Yamanashi (JP)

(73) Assignee: Masterlink Corporation, Minato-ku, Tokyo (JP)

(21) Appl. No.: 15/319,315

(22) PCT Filed: Jun. 12, 2015
(86) PCT No.: PCT/JP2015/067058

§ 371 Date: Mar. 2, 2017

(30) Foreign Application Priority Data
Jun. 17, 2014 (JP) 2014-124714

(51) Int. Cl. B67B 3/14

(52) U.S. Cl. CPC B67B 3/14

(57) ABSTRACT

The first-arm-curved-part includes a first open-circumferential-edge contact surface that is capable of touching a part that has a length of 3 mm to 6 mm in the circumferential direction of the open circumferential edge. The second-arm-curved-part includes a second open-circumferential-edge contact surface that is capable of touching a part that has a length of 3 mm to 6 mm in the circumferential direction of the open circumferential edge. The distance between the first gripping part and the second gripping part is 35 mm to 45 mm, when the first open-circumferential-edge contact surface and the second open-circumferential-edge contact surface touch the open circumferential edge to hold the pilfer-proof cap with the first arm and the second arm.

### TECHNICAL FIELD

The present invention relates to a pilfer-proof cap crimping tool configured to crimp a pilfer-proof cap to a juice-bottle and the like to seal the mouth of the bottle and the like.

### BACKGROUND ART

Conventionally, a pilfer-proof cap crimping device that automatically crimps pilfer-proof caps to juice-bottles and the like to seal the mouths of the bottles and the like is known (see Patent Document 1). Such a pilfer-proof cap crimping device presses a pilfer-proof cap from three sides by using a roller to crimp the pilfer-proof cap to the mouth of a bottle.

Patent Document 1: Japanese Unexamined Patent Application, Publication No. 2010-159084

### DISCLOSURE OF THE INVENTION

### Problems to be Solved by the Invention

However, such a conventional pilfer-proof cap crimping device has a complicated structure, and is very expensive, specifically the price thereof is 1.5 million yen or more. Accordingly, an inexpensive tool with a simple structure for crimping pilfer-proof caps has been desired.

The present invention is to provide a pilfer-proof cap crimping tool that crimps pilfer-proof caps to seal the mouths of juice-bottles and the like.

### Means for Solving the Problems

The present invention relates to a pilfer-proof cap crimping tool including a first arm having one end and another end, and extending from the one end to the another end, and a second arm having one end and another end, and extending from the one end to the another end, wherein the one end of the first arm includes a first arm connection part, the one end of the second arm includes a second arm connection part connected to the first arm connection part of the first arm in a rotatable manner with respect to the first arm, the first arm includes a first-arm-curved-part that is curved at a part between the one end and the another end of the first arm to separate it from the second arm, and a first gripping part that is positioned nearer to the another end of the first arm in comparison to the first-arm-curved-part to be gripped by a hand of a user, the second arm includes a second-arm-curved-part that is curved at a part opposite to the first-arm-curved-part between the one end and the another end of the second arm to separate it from the first arm, and a second gripping part that is positioned nearer to the another end of the second arm in comparison to the second-arm-curved-part to be gripped by the hand of the user, the first-arm-curved-part includes a first open-circumferential-edge contact surface that is configured to touch a part of an open circumferential edge of a pilfer-proof cap, the part of the open circumferential edge of the pilfer-proof cap having a length of 3 mm to 6 mm in a circumferential direction of the open circumferential edge, the second-arm-curved-part includes a second open-circumferential-edge contact surface that is configured to touch a part of the open circumferential edge of the pilfer-proof cap, the part of the open circumferential edge of the pilfer-proof cap having a length of 3 mm to 6 mm in the circumferential direction of the open circumferential edge, and a distance between the first gripping part and the second gripping part is 35 mm to 45 mm, when the first open-circumferential-edge contact surface and the second open-circumferential-edge contact surface touch the open circumferential edge to hold the pilfer-proof cap with the first arm and the second arm.

It is preferable that when the first open-circumferential-edge contact surface and the second open-circumferential-edge contact surface are in contact with the open circumferential edge, an angle formed by a straight line connecting the first open-circumferential-edge contact surface and the center of the pilfer-proof cap and a straight line connecting the second open-circumferential-edge contact surface and the center of the pilfer-proof cap on a side of the first arm connection part with respect to the center of the pilfer-proof cap is equal to or less than 180°.

It is preferable that each of the first arm and the second arm has a circular cross section which is orthogonal to a longitudinal direction of each of the first arm and the second arm, and the diameter of the cross section is 5.5 mm to 8.0 mm.

It is preferable that when a circumferential surface of an opening part of a bottle-shaped container to which the pilfer-proof cap is crimped has an external thread, and the external thread includes a flange on a side opposite to an open end of the opening part, the first-arm-curved-part includes a first flange-contact-surface configured to make contact with the flange when the first open-circumferential-edge contact surface and the second open-circumferential-edge contact surface touch the open circumferential edge of the pilfer-proof cap to hold the pilfer-proof cap with the first arm and the second arm, and the second-arm-curved-part includes a second flange-contact-surface configured to make contact with the flange when the first open-circumferential-edge contact surface and the second open-circumferential-edge contact surface touch the open circumferential edge of the pilfer-proof cap to hold the pilfer-proof cap with the first arm and the second arm.

It is preferable that at least one of the first arm and the second arm includes a top plate contact part configured to make contact with a top plate of the pilfer-proof cap when at least one of the first open-circumferential-edge contact surface and the second open-circumferential-edge contact surface touches the open circumferential edge of the pilfer-proof cap.

### Effects of the Invention

The present invention can provide a pilfer-proof cap crimping tool that crimps pilfer-proof caps to seal the mouths of juice-bottles and the like.

### BRIEF DESCRIPTION OF THE DRAWINGS

FIG. 1 is a perspective view of a pilfer-proof cap crimping tool 1 according to a first embodiment of the present invention.

FIG. 2 is a plan view showing a state in which the pilfer-proof cap crimping tool 1 according to the first embodiment of the present invention crimps a pilfer-proof cap 2.

FIG. 3 is a partial sectional view taken along line a-a in FIG. 2.

FIG. 4 is a bottom perspective view of a pilfer-proof cap crimping tool 1A according to a second embodiment of the present invention.

FIG. 5 is a perspective view showing a state in which the pilfer-proof cap crimping tool 1A according to the second embodiment of the present invention crimps the pilfer-proof cap 2.

FIG. 6 is a partial sectional view showing a state in which the pilfer-proof cap crimping tool 1A according to the second embodiment of the present invention crimps the pilfer-proof cap 2.

### PREFERRED MODE FOR CARRYING OUT THE INVENTION

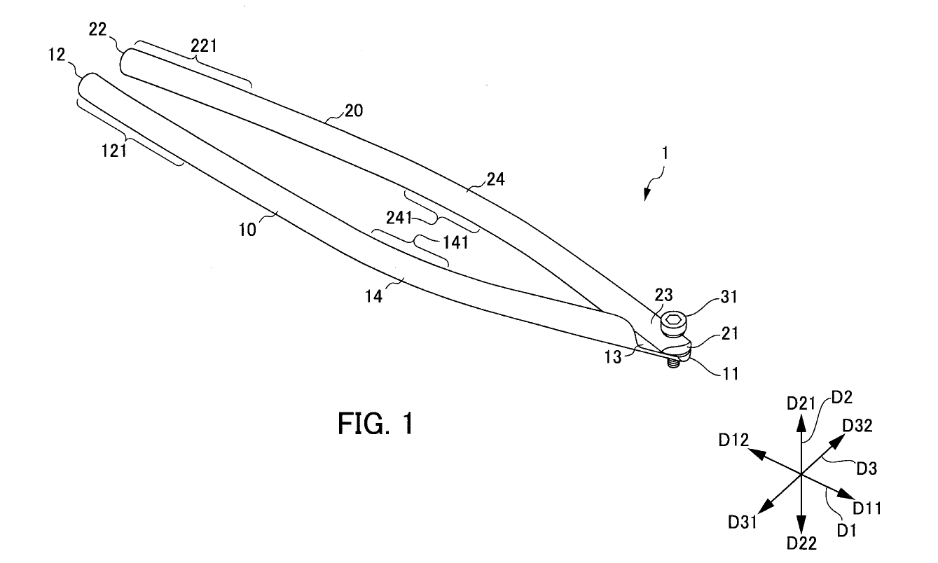

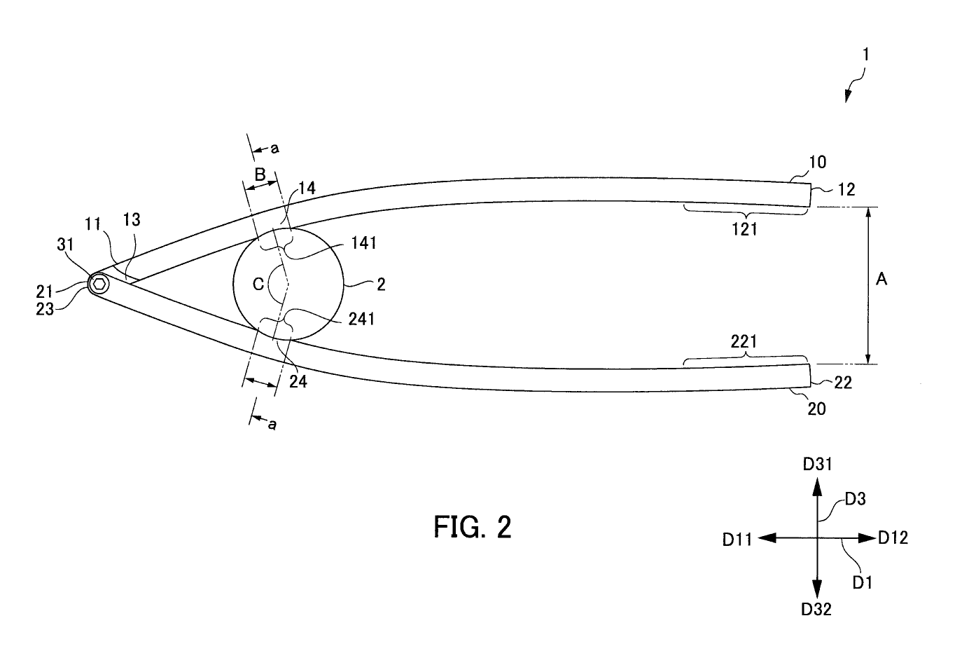

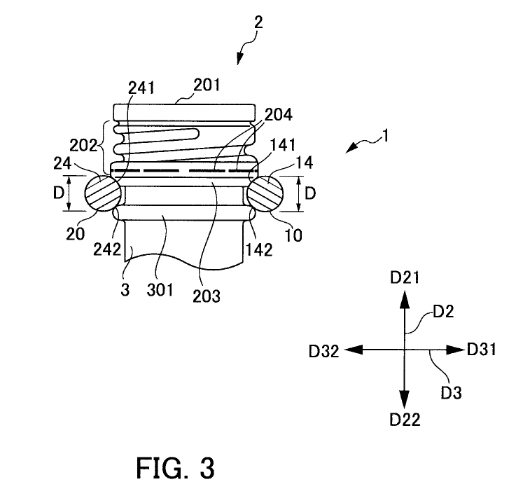

A pilfer-proof cap crimping tool according to a first embodiment of the present invention is described in detail below with reference to the drawings. FIG. 1 is a perspective view of a pilfer-proof cap crimping tool 1 according to the first embodiment of the present invention. FIG. 2 is a plan view showing a state in which the pilfer-proof cap crimping tool 1 according to the first embodiment of the present invention crimps a pilfer-proof cap 2. FIG. 3 is a partial sectional view taken along line a-a in FIG. 2.

Here, for easy understanding, referring to FIG. 2, when a first-arm-curved-part 14 and a second-arm-curved-part 24 hold and crimp the pilfer-proof cap 2, a direction from another end 12, 22 to one end 11, 21 of each of a first arm 10 and a second arm 20 (a direction from the right side to the left side in FIG. 2) is defined as a front direction D11, a direction opposite thereto is defined as a backward direction D12, and these directions are defined as front-and-back directions D1. A direction which is orthogonal to the front-and-back directions D1 and is also orthogonal to a direction connecting the first arm 10 and the second arm 20, and which is a direction from a first arm connection part 13 to a second arm connection part 23 (a direction from the back side to the front side of the page of FIG. 2) is defined as an upward direction D21 (see FIG. 1 and the like), the direction opposite thereto is defined as a downward direction D22, and these directions are defined as up-and-down directions D2. A direction from the second arm 20 to the first arm 10 (upward direction in FIG. 2) is defined as a left direction D31, and a direction opposite thereto is defined as a right direction D32, and these directions are defined as left-and-right directions D3.

A pilfer-proof cap 2 (hereinafter referred to as a “PP cap 2”) which is to be crimped by the pilfer-proof cap crimping tool 1 is capable of closing opening parts of bottle-type containers, such as a bottle 3 of grape juice and a piccolo sized wine bottle, as shown in FIG. 3 and the like, and is made of an aluminum alloy. Referring to FIG. 3, the PP cap 2 includes a top plate 201, a cylindrical part 202, and a PP band 203 (pilfer-proof band 203).

The top plate 201 has a substantially disk shape. The cylindrical part 202 has a cylindrical shape. The upper end of the cylindrical part 202 is integrated with and connected to the circumferential edge of the top plate 201 to close an opening at the upper end of the cylindrical part 202. The inner surface of the cylindrical part 202 has an internal thread (not shown). The internal thread of the cylindrical part 202 is configured to screw with an external thread formed on the opening part of the bottle 3 (not shown).

The PP band 203 is integrated with and connected to the lower end of the cylindrical part 202 in such a manner that the PP band 203 is coaxial with the cylindrical part 202. A score line 204, which includes cuttings at predetermined intervals in a circumferential direction of the cylindrical part 202, is formed between the PP band 203 and the lower end of the cylindrical part 202. The PP band 203 and the lower end of the cylindrical part 202 are configured to be separated at the position of the score line 204 by rotating the top plate 201 and the cylindrical part 202 in a direction to loosen a screw-engagement between the external thread of the opening part of the bottle 3 and the internal thread of the cylindrical part 202.

The pilfer-proof cap crimping tool 1 crimps and deforms the lower end of the PP band 203 in such a manner that the diameter of the PP band 203 is reduced as shown in FIG. 3. The PP band 203 is fixed to a lower part of the external thread (not shown) of the opening part of the bottle 3.

Referring to FIG. 1, the pilfer-proof cap crimping tool 1 includes the first arm 10 and the second arm 20. The first arm 10 includes the one end 11 and the another end 12, and extends from the one end 11 to the another end 12. In the same manner, the second arm 20 includes the one end 21 and the another end 22, and extends from the one end 21 to the another end 22. Each of the first arm 10 and the second arm 20 is made of brass, and has a length of about 190 mm in a longitudinal direction.

Referring to FIG. 3, each of the first arm 10 and the second arm 20 has a circular cross section orthogonal to the longitudinal direction of each of the first arm 10 and the second arm 20, and the diameter D of the cross section is 5.5 mm to 8.0 mm. According to this embodiment, the diameter D of the cross section is 8.0 mm. The lower limit of the diameter D of the cross section is 5.5 mm because the diameter D having a value less than 5.5 mm causes a squamous pattern and/or a crack at the mouth of the crimped cap, i.e., a squamous pattern and/or a crack is generated at the PP band 203. The uppermost value of the diameter D of the cross section is 8.0 mm because the diameter D having a value equal to or less than 8.0 mm makes it possible to crimp and bend the mouth of the cap, i.e., the PP band 203 up to around 45° with respect to the up-and-down directions D2. The diameter D having a value equal to or less than 8.0 mm also makes it possible to set a part subject to such bending at about 1 mm to 2 mm from the lowermost end of the PP band 203 in the up-and-down directions D2. Bending the mouth of the cap in this manner reduces a risk of a user cutting his hand on the bent part.

Each of the first arm 10 and the second arm 20 has a curved shape so as to be separated from each other at a part between the one end 11, 21 and the another end 12, 22. Specifically, the first arm 10 includes the first-arm-curved-part 14 and a first gripping part 121. The first-arm-curved-part 14 is a part between the one end 11 and the another end 12 of the first arm 10, and forms a part closer to the one end 11. The first-arm-curved-part 14 is curved to be separated from the second arm 20. The first gripping part 121 is positioned closer to the another end 12 of the first arm 10 in comparison to the first-arm-curved-part 14, and forms a part near the another end 12 of the first arm 10 to be gripped by the user.

In the same manner, the second arm 20 includes the second-arm-curved-part 24 and a second gripping part 221. The second-arm-curved-part 24 is a part between the one end 21 and the another end 22 of the second arm 20, and forms a part closer to the one end 21. The second-arm-curved-part 24 is curved to be separated from the first-arm-curved-part 14 of the first arm 10. The second gripping part 221 is positioned closer to the another end 22 of the second arm 20 in comparison to the second-arm-curved-part 24, and forms a part near the another end 22 of the second arm 20 to be gripped by the user together with the first gripping part 121.

The one end 11 of the first arm 10 includes a first arm connection part 13. The first arm connection part 13 has a shape formed by scraping the upper half of the one end 11 of the first arm 10. The first arm connection part 13 includes a through hole (not shown).

The one end 21 of the second arm 20 includes a second arm connection part 23. The second arm connection part 23 has a shape formed by scraping the lower half of the one end 21 of the second arm 20. The second arm connection part 23 includes a through hole (not shown). A screw 31 is inserted in the through hole of the first arm connection part 13 and the through hole of the second arm connection part 23, and the tip end of the screw 31 is screw-engaged with a nut (not shown). With this configuration, the second arm connection part 23 at the one end 21 of the second arm 20 is connected to the first arm connection part 13 of the first arm 10 in a rotatable manner with respect to the first arm 10.

The first-arm-curved-part 14 includes a first open-circumferential-edge contact surface 141. The second-arm-curved-part 24 includes a second open-circumferential-edge contact surface 241. Referring to FIGS. 2 and 3, when a user grips the first gripping part 121 and the second gripping part 221, the first arm 10 and the second arm 20 hold the PP cap 2 while allowing the first open-circumferential-edge contact surface 141 and the second open-circumferential-edge contact surface 241 to come in contact with an open circumferential edge of the PP cap 2. When the first arm 10 and the second arm 20 hold the PP cap 2, the first open-circumferential-edge contact surface 141 and the second open-circumferential-edge contact surface 241 are capable of touching a part B that is a part of the open circumferential edge of the PP cap 2 and has a length of 3 mm to 6 mm in a circumferential direction of the open circumferential edge. More specifically, referring to FIG. 3, the outer surface of the upper side of each of the first-arm-curved-part 14 and the second-arm-curved-part 24 are in contact with the lower end of the cylindrical part of the PP cap 2 in a range indicated by the part B in FIG. 2.

The outer surface of the lower side of each of the first-arm-curved-part 14 and the second-arm-curved-part 24 is in contact with a flange 301 (see FIG. 3), which is formed at the opening part of the bottle 3 on a side opposite to an open end of the opening part with respect to the external thread of the bottle 3 (a side nearer to the bottom of the bottle 3). In other words, the first-arm-curved-part 14 includes a first flange-contact-surface 142 capable of coming into contact with the flange 301 when the first arm 10 and the second arm 20 hold the PP cap 2 while allowing the first open-circumferential-edge contact surface 141 and the second open-circumferential-edge contact surface 241 to come in contact with an open circumferential edge of the PP cap 2. In the same manner, the second-arm-curved-part 24 includes a second flange-contact-surface 242 capable of coming into contact with the flange 301 when the first arm 10 and the second arm 20 hold the PP cap 2 while allowing the first open-circumferential-edge contact surface 141 and the second open-circumferential-edge contact surface 241 to come in contact with an open circumferential edge of the PP cap 2.

At this time, a distance A (see FIG. 2) between the first gripping part 121 and the second gripping part 221 is in a range of 35 mm to 45 mm.

In addition, an angle C is formed at this time, as shown in FIG. 2. The angle C is, in a plan view of FIG. 2, an angle formed by a straight line connecting the first open-circumferential-edge contact surface 141 and the center of the PP cap 2 (a chain double-dashed line in FIG. 2) and a straight line connecting the second open-circumferential-edge contact surface 241 and the center of the PP cap 2 (the other chain double-dashed line in FIG. 2) when the first open-circumferential-edge contact surface 141 and the second open-circumferential-edge contact surface 241 are in contact with the open circumferential edge of the PP cap 2. The angle C is an angle on the side of the first arm connection part 13 and the second arm connection part 23 with respect to the center of the PP cap 2. The angle C is preferably equal to or less than 180°, and is approximately 150° in the present embodiment.

The operations of crimping the PP cap 2 using the above-described pilfer-proof cap crimping tool 1 is described below.

First, the PP cap 2 is placed over the opening part of the bottle 3 to close the opening part of the bottle 3, and is rotated like fastening a screw with respect to the bottle 3 to tighten the opening part of the bottle 3. Next, as shown in FIG. 2, the first open-circumferential-edge contact surface 141 and the second open-circumferential-edge contact surface 241 are made to come into contact with the open circumferential edge of the PP cap 2, and also the first flange-contact-surface 142 and the second flange-contact-surface 242 are made to come into contact with the flange 301. Then, the user grips the first gripping part 121 and the second gripping part 221 of the pilfer-proof cap crimping tool 1 with one hand and crimps the open circumferential edge of the PP cap 2 with the pilfer-proof cap crimping tool 1 in such a manner that the first gripping part 121 and the second gripping part 221 come close to each other.

Subsequently, while maintaining the state, the PP cap 2 is rotated relative to the opening part of the bottle 3 (see FIG. 3), and the pilfer-proof cap crimping tool 1 is rotated one turn relative to the opening part of the bottle 3 in such a manner that the PP cap 2 is tightened onto the opening part of the bottle 3. At this time, the angle C is 150°, which is equal to or less than 180°, and thus, a force to move the PP cap 2 in the backward direction D12 in a plan view of FIG. 2 acts on the PP cap 2 when the first open-circumferential-edge contact surface 141 and the second open-circumferential-edge contact surface 241 crimp the PP cap 2. Accordingly, the PP cap 2 slides against the first open-circumferential-edge contact surface 141 and the second open-circumferential-edge contact surface 241, and moves in the backward direction D12 with respect to the pilfer-proof cap crimping tool 1. This causes the lower end of the PP band 203, which is the open circumferential edge of the PP cap 2, to be modified and crimped to reduce the diameter of the PP band 203, thereby fixing the PP cap 2 to the opening part of the bottle 3.

Then, testing was conducted to test the effects of the present invention by using the pilfer-proof cap crimping tool 1 according to the first embodiment. In the testing, Inventive product 1, Inventive product 2, and Inventive product 3 of the pilfer-proof cap crimping tool 1 according to the first embodiment were prepared in which the distance A in FIG. 2 is 40 mm, the angle C in FIG. 2 is 150°, the diameter D in FIG. 3 is 7 mm, and the length of the part B in FIG. 2 is 3 mm, 5 mm, and 6 mm, respectively. Inventive product 4, Inventive product 5, and Inventive product 6 of the pilfer-proof cap crimping tool 1 according to the first embodiment were prepared in which the length of the part B in FIG. 2 is 5 mm, the angle C in FIG. 2 is 150°, the diameter D in FIG. 3 is 7 mm, and the distance A in FIG. 2 is 35 mm, 40 mm, and 45 mm respectively. Inventive product 7 and Inventive product 8 of the pilfer-proof cap crimping tool 1 according to the first embodiment were prepared in which the distance A in FIG. 2 is 40 mm, the length of the part B in FIG. 2 is 5 mm, the diameter D in FIG. 3 is 7 mm, and the angle C in FIG. 2 is 150° and 170°, respectively. Inventive product 9, Inventive product 10, and Inventive product 11 of the pilfer-proof cap crimping tool 1 according to the first embodiment were prepared in which the distance A in FIG. 2 is 40 mm, and the length of the part B in FIG. 2 is 5 mm, and the angle C in FIG. 2 is 150°, and the diameter D in FIG. 3 is 5.5 mm, 7 mm, and 8.0 mm respectively.

Comparative product 1 and Comparative product 2 of pilfer-proof cap crimping tools were prepared in which the distance A in FIG. 2 is 40 mm, the angle C in FIG. 2 is 150°, the diameter D in FIG. 3 is 7 mm, and the length of the part B in FIG. 2 is 2.5 mm and 6.5 mm respectively. Comparative product 3 and Comparative product 4 of pilfer-proof cap crimping tools were prepared in which the length of the part B in FIG. 2 is 5 mm, the angle C in FIG. 2 is 150°, the diameter D in FIG. 3 is 7 mm, and the distance A in FIG. 2 is 30 mm and 50 mm respectively. Comparative product 5 of a pilfer-proof cap crimping tool was prepared in which the distance A in FIG. 2 is 40 mm, the length of the part B in FIG. 2 is 5 mm, the diameter D in FIG. 3 is 7 mm, and the angle C in FIG. 2 is 185°. Comparative product 6 and Comparative product 7 of pilfer-proof cap crimping tools were prepared in which the distance A in FIG. 2 is 40 mm, the length of the part B in FIG. 2 is 5 mm, the angle C in FIG. 2 is 150°, and the diameter D in FIG. 3 is 5.0 mm and 8.5 mm respectively.

After the PP cap 2 is rotated and tightened to close the opening part of the bottle 3, eight women practically conducted crimping operations by using Inventive products 1 to 11 and Comparative products 1 to 7. The testing results are shown in Tables 1 to 4.

TABLE 1

| | | | | Compar- | Compar- |
|---|---|---|---|---|---|
| | Inventive | Inventive | Inventive | ative | ative |
| | product 1 | product 2 | product 3 | product 1 | product 2 |
| Scratched | 0 | 0 | 0 | 7 | 0 |
| Crimping | 0 | 0 | 0 | 0 | 6 |
| defect | | | | | |

As shown in Table 1, none of Inventive products 1 to 3 caused a noticeable scratch to the PP cap 2 and securely crimped the PP cap 2 without causing a crimping defect by rotating the pilfer-proof cap crimping tool one turn relative to the opening part of the bottle 3. On the other hand, seven out of the eight women using Comparative product 1 caused a scratch to the PP cap 2, and each of the bottles 3 after crimping is not in a condition suitable for a product. Regarding Comparative product 2, six out of the eight women were not able to securely crimp the PP cap 2 by rotating the pilfer-proof cap crimping tool one turn relative to the opening part of the bottle 3, and required an additional one or two turns to securely finish the crimping work.

In view of the above, it is evident that the pilfer-proof cap crimping tool 1 in which the length of the part B is set to be 3 mm to 6 mm like Inventive products 1 to 3 reliably performs the crimping operation without causing a scratch to the PP cap 2 with a rotation of one turn relative to the opening part of the bottle 3.

TABLE 2

| | | | | Compar- | Compar- |
|---|---|---|---|---|---|
| | Inventive | Inventive | Inventive | ative | ative |
| | product 4 | product 5 | product 6 | product 3 | product 4 |
| Too wide | 0 | 0 | 0 | 0 | 6 |
| Too narrow | 0 | 0 | 0 | 6 | 0 |

As shown in Table 2, none of the eight women felt that the distance between the first gripping part 121 and the second gripping part 221 of each of Inventive products 4 to 6 was too wide or too narrow when gripping the first gripping part 121 and the second gripping part 221 of the pilfer-proof cap crimping tool with one hand. On the other hand, six out of the eight women felt that the distance between the first gripping part 121 and the second gripping part 221 of Comparative product 3 was too narrow. In addition, six out of the eight women felt that the distance between the first gripping part 121 and the second gripping part 221 of Comparative product 4 was too wide. The women who felt the distance to be too narrow or too wide felt that it would be hard to conduct the crimping operation by using Comparative product 3 or Comparative product 4 for long hours. In view of the above, it is evident that setting the distance A to be 35 mm to 45 mm like Inventive products 4 to 6 allows the pilfer-proof cap crimping tool to have an appropriate distance between the first gripping part 121 and the second gripping part 221 and enables hours of extended use of the pilfer-proof cap crimping tool 1.

TABLE 3

| | | | Compar- |
|---|---|---|---|
| | Inventive | Inventive | ative |
| | product 7 | product 8 | product 5 |
| Move in backward | 8 | 8 | 0 |
| direction D12 | | | |

As shown in Table 3, both of Inventive products 7 and 8 caused the PP cap 2 to slide against the first open-circumferential-edge contact surface 141 and the second open-circumferential-edge contact surface 241 and to move in the backward direction D12 with respect to the pilfer-proof cap crimping tool 1. On the other hand, when Comparative product 5 was tested by the eight women, the PP cap 2 never moved in the backward direction D12 with respect to the pilfer-proof cap crimping tool 1. In view of the above, it is evident that the angle C set to be equal to or less than 180° such as 150° □ and 170° □ allows the PP cap 2 to reliably move in the backward direction D12 and allows each of the first open-circumferential-edge contact surface 141 and the second open-circumferential-edge contact surface 241 to make contact with a wide area of the PP cap 2. As a result, it is evident that Inventive products 7 and 8 minimize early wearing of the first open-circumferential-edge contact surface 141 and the second open-circumferential-edge contact surface 241.

TABLE 4

| | | | | Compar- | Compar- |
|---|---|---|---|---|---|
| | Inventive | Inventive | Inventive | ative | ative |
| | product 9 | product 10 | product 11 | product 6 | product 7 |
| Good | 8 | 8 | 8 | 1 | 8 |
| finished | | | | | |
| quality | | | | | |
| Good in | 8 | 8 | 8 | 8 | 0 |
| terms of | | | | | |
| safety | | | | | |

As shown in Table 4, the finished quality of the PP cap 2 after crimping by using any of Inventive products 9, 10, 11 was good without causing a squamous pattern and/or a crack. In addition, the PP band 203 after crimping was bent up to around 45° with respect to the up-and-down directions D2. The bent part was measured at about 1 mm to 2 mm from the lowermost end of the PP band 203 in the up-and-down directions D2. Accordingly, a risk of the user cutting her hand on the bent part is extremely low, and thus Inventive products 9, 10, 11 are also good in terms of safety.

On the other hand, regarding Comparative product 6, only one out of the eight women was able to achieve a good finished quality without causing a squamous pattern and/or a crack. In view of this, a good finished quality is achieved by setting the diameter D of the cross section to be equal to or larger than 5.5 mm.

In addition, regarding Comparative product 7, none of the eight women was able to bend the PP band 203 after crimping up to around 45° with respect to the up-and-down directions D2. Moreover, regarding Comparative product 7, none of the eight women was able to have the bent part to be measured to be at about 1 mm to 2 mm from the lowermost end of the PP band 203 in the up-and-down directions D2. In other words, Comparative product 7 was not able to provide safety. In view of this, a pilfer-proof cap crimping tool 1 provides safety if the diameter D of the cross section is set to be equal to or less than 8.0 mm.

The effects of the pilfer-proof cap crimping tool 1 according to the first embodiment are described below. As described above, a pilfer-proof cap crimping tool 1 includes the first arm 10 having the one end 11 and the another end 12, and extends from the one end 11 to the another end 12, and the second arm 20 having the one end 21 and the another end 22, and extends from the one end 21 to the another end 22, wherein the one end 11 of the first arm 10 includes the first arm connection part 13, the one end 21 of the second arm 20 includes the second arm connection part 23 connected to the first arm connection part 13 of the first arm 10 in a rotatable manner with respect to the first arm 10, the first arm 10 includes the first-arm-curved-part 14 that is curved at a part between the one end 11 and the another end 12 of the first arm 10 to separate it from the second arm 20, and the first gripping part 121 that is positioned nearer to the another end 12 of the first arm 10 in comparison to the first-arm-curved-part 14 to be gripped by a hand of a user, and the second arm 20 includes the second-arm-curved-part 24 that is curved at a part opposite to the first-arm-curved-part 14 between the one end 21 and the another end 22 of the second arm 20 to separate it from the first arm 10, and the second gripping part 221 that is positioned nearer to the another end 22 of the second arm 20 in comparison to the second-arm-curved-part 24 to be gripped by the hand of the user.

The first-arm-curved-part 14 includes the first open-circumferential-edge contact surface 141 that is configured to touch a part B of the open circumferential edge of the PP cap 2, the part of the open circumferential edge of the PP cap 2 having a length of 3 mm to 6 mm in a circumferential direction of the open circumferential edge, and the second-arm-curved-part 24 includes the second open-circumferential-edge contact surface 241 that is configured to touch a part B of the open circumferential edge of the PP cap 2, the part of the open circumferential edge of the PP cap 2 having a length of 3 mm to 6 mm in the circumferential direction of the open circumferential edge. A distance A between the first gripping part 121 and the second gripping part 221 is 35 mm to 45 mm, when the first open-circumferential-edge contact surface 141 and the second open-circumferential-edge contact surface 241 touch the open circumferential edge to hold the pilfer-proof cap with the first arm 10 and the second arm 20.

This configuration enables continuous crimping while minimizing the fatigue of the hand of a user even when a woman, who has a relatively weak grip, uses the pilfer-proof cap crimping tool 1 for long hours. This configuration also minimizes a risk of the PP cap 2 becoming scratched during the crimping work. In addition, this configuration makes it possible to finish the crimping work with only one turn of the pilfer-proof cap crimping tool 1 relative to the opening part of the bottle 3 in such a manner that the PP cap 2 is tightened onto the opening part of the bottle 3. Accordingly, the PP cap 2 is crimped by a relatively weak force in comparison to a conventional case in which a pilfer-proof cap crimping device is used, thereby minimizing occurrence of a crack occurring at the external thread on the circumference surface of the opening part of a bottle-shaped container due to the crimping force.

When the first open-circumferential-edge contact surface 141 and the second open-circumferential-edge contact surface 241 are in contact with the open circumferential edge, an angle formed by a straight line connecting the first open-circumferential-edge contact surface 141 and the center of the PP cap 2 and a straight line connecting the second open-circumferential-edge contact surface 241 and the center of the PP cap 2 on a side of the first arm connection part 13 with respect to the center of the PP cap 2 is equal to or less than 180°.

This configuration allows the PP cap 2 to easily slide against the first open-circumferential-edge contact surface 141 and the second open-circumferential-edge contact surface 241 and to easily move in the backward direction D12 with respect to the pilfer-proof cap crimping tool 1 during the crimping work.

In addition, each of the first arm 10 and the second arm 20 has a circular cross section which is orthogonal to a longitudinal direction of each of the first arm 10 and the second arm 20, and the diameter of the cross section is 5.5 mm to 8.0 mm. This configuration minimizes occurrence of a squamous pattern and/or a crack on the crimped PP band 203, and also reduces a risk of the user cutting her hand on the PP band 203 after crimping to an extremely low level.

The first-arm-curved-part 14 includes a first flange-contact-surface 142 configured to make contact with the flange 301 when the first open-circumferential-edge contact surface 141 and the second open-circumferential-edge contact surface 241 touch the open circumferential edge of the PP cap 2 to hold the PP cap 2 with the first arm 10 and the second arm 20. The second-arm-curved-part 24 includes a second flange-contact-surface 242 configured to make contact with the flange 301 when the first open-circumferential-edge contact surface 141 and the second open-circumferential-edge contact surface 241 touch the open circumferential edge of the PP cap to hold the PP cap with the first arm 10 and the second arm 20.

With this configuration, the first flange-contact-surface 142 and the second flange-contact-surface 242 come in contact with the flange 301, and thus the first open-circumferential-edge contact surface 141 and the second open-circumferential-edge contact surface 241 stably touch the open circumferential edge of the PP cap 2.

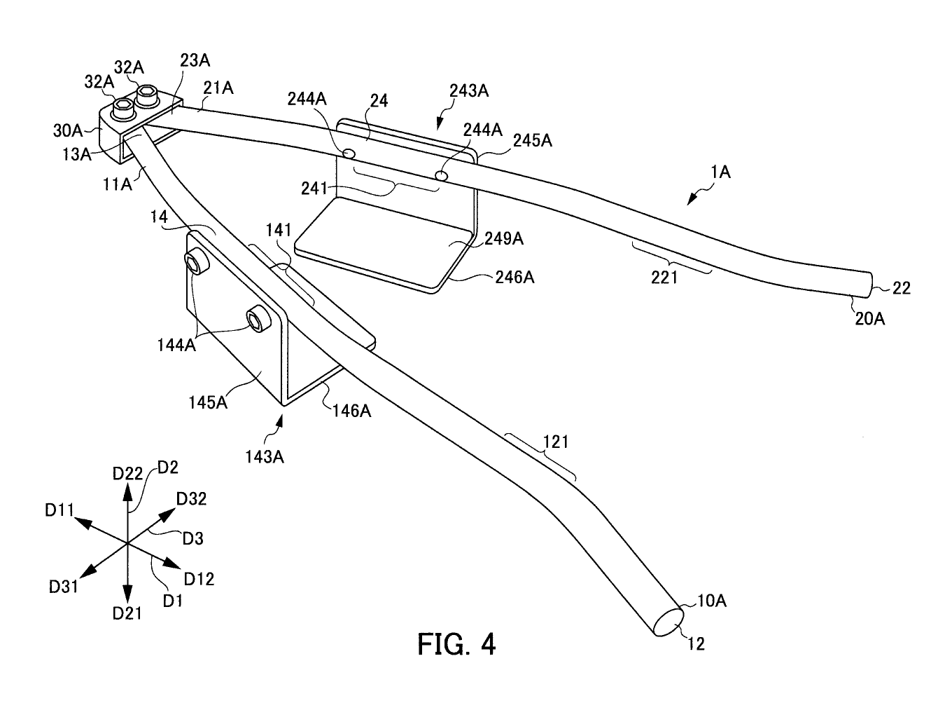

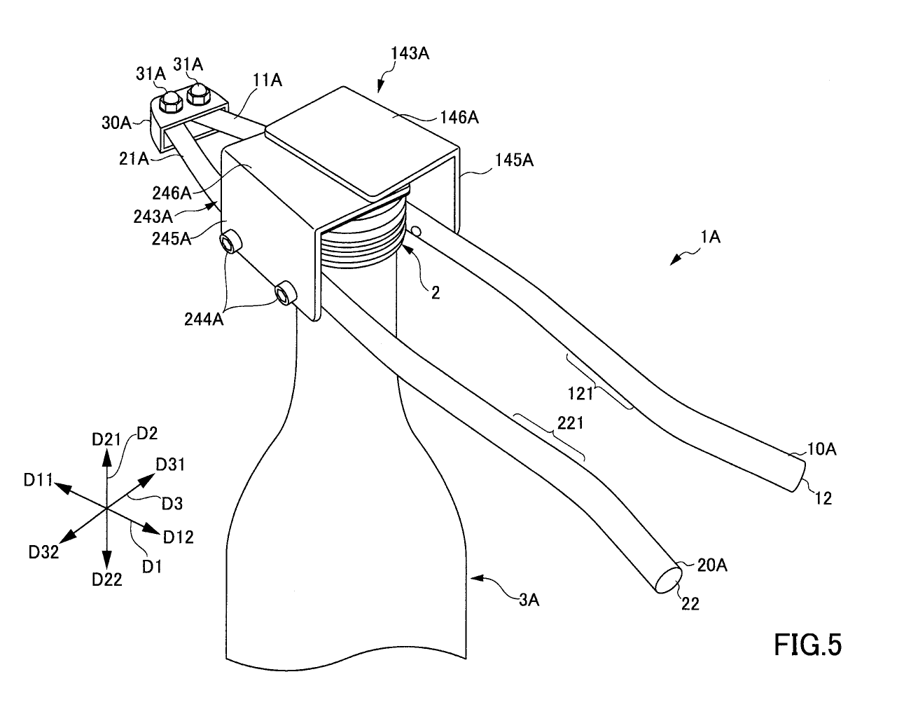

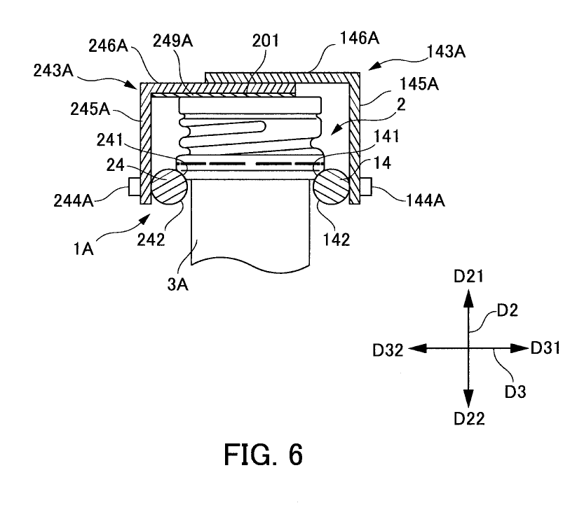

A pilfer-proof cap crimping tool according to a second embodiment of the present invention is described below with reference to the drawings. FIG. 4 is a bottom perspective view of a pilfer-proof cap crimping tool 1A according to the second embodiment of the present invention. FIG. 5 is a perspective view showing a state in which the pilfer-proof cap crimping tool 1A according to the second embodiment crimps a PP cap 2. FIG. 6 is a partial sectional view showing a state in which the pilfer-proof cap crimping tool 1A according to the second embodiment crimps the PP cap 2.

The pilfer-proof cap crimping tool 1A according to the second embodiment differs from the pilfer-proof cap crimping tool 1 according to the first embodiment in that the pilfer-proof cap crimping tool 1A includes a top plate contact part. In addition, the shapes of a first arm 10A and a second arm 20A and the configurations of a first arm connection part 13A and a second arm connection part 23A are different from those of the first embodiment. The other components are the same as those of the pilfer-proof cap crimping tool 1 according to the first embodiment, and thus the components that are the same as those of the first embodiment are denoted by the same reference numerals and descriptions thereof are omitted.

Referring to FIG. 4 and the like, a part of the first arm 10A and a part of the second arm 20A near the another ends 12, 22 are respectively bent so as to be separated from each other toward the another ends of the first arm 10A and the second arm 20A from the first gripping part 121 and the second gripping part 221. The thicknesses of the first arm connection part 13A and the second arm connection part 23A are the same as the thicknesses in the up-and-down directions D2 of the parts of the first arm 10A and the second arm 20A other than the first arm connection part 13A and the second arm connection part 23A.

The pilfer-proof cap crimping tool 1A includes a box-shaped part 30A having a substantially trapezoidal shape in plan view. A part of the box-shaped part 30A corresponding to the bottom of the trapezoid is an opening part, and one end 11A of the first arm 10A and one end 21A of the second arm 20A are inserted in the opening part. Two through holes (not shown) are arranged side by side in the left-and-right directions D3 on each of the upper wall and the lower wall of the box-shaped part 30A. A screw 31A (see FIG. 5) is inserted in one of the through holes on the upper wall, in a through hole formed in the first arm connection part 13A, and in one of the through holes on the lower wall. The tip end of the screw 31A is screw-engaged with a nut. In the same manner, another screw 31A is inserted in the other one of the through holes on the upper wall, in a through hole formed in the second arm connection part 23A, and in the other one of the through holes on the lower wall. The tip end of the screw 31A is screw-engaged with a nut 32A.

With this configuration, the second arm connection part 23A at the one end 21A of the second arm 20A is connected to the first arm connection part 13A of the first arm 10A in a rotatable manner with respect to the first arm 10A. More specifically, the first arm connection part 13A of the first arm 10A and the second arm connection part 23A on the one end 21A of the second arm 20A are both rotatable with respect to the box-shaped part 30A, and thus the second arm connection part 23A on the one end 21A of the second arm 20A is rotatable with respect to the first arm connection part 13A on the one end 11A of the first arm 10A. When the first arm connection part 13A and the second arm connection part 23A are rotated so as to be separated from each other, the first arm connection part 13A and the second arm connection part 23A abut against the box-shaped part 30A, thereby being restrained from rotating further. The box-shaped part 30A functions as a stopper.

The top plate contact part includes a first top plate contact part 143A and a second top plate contact part 243A. Each of the first top plate contact part 143A and the second top plate contact part 243A is formed by bending a rectangular plate-like member into an L-shape, and includes a rectangular up-and-down direction wall 145A, 245A and a lateral wall 146A, 246A. Through holes are formed near both ends in the front-and-back directions D1 of the lower part of the first top plate contact part 143A. Two through holes are formed also in the first-arm-curved-part 14. Fixing screws 144A are respectively threaded through the through holes formed near both ends of the first top plate contact part 143A and the through holes formed in the first-arm-curved-part 14. With this configuration, the first top plate contact part 143A is fixed to the first-arm-curved-part 14.

In the same manner, through holes are formed near both ends in the front-and-back directions D1 of the lower part of the second top plate contact part 243A. Two through holes are formed also in the second-arm-curved-part 24. Fixing screws 244A are respectively threaded through the through holes formed near both ends of the second top plate contact part 243A and the through holes formed in the second-arm-curved-part 24. With this configuration, the second top plate contact part 243A is fixed to the second-arm-curved-part 24. A felt cloth 249A is attached to the entire surface of the lower surface of the lateral wall 246A of the second top plate contact part 243A.

The operations of crimping the PP cap 2 using the above described pilfer-proof cap crimping tool 1A is described below.

First, the PP cap 2 is placed over the opening part of a bottle 3A to close the opening part of the bottle 3A, and is rotated like fastening a screw with respect to the bottle 3A to tighten the opening part of the bottle 3A. Next, as shown in FIG. 6, the first open-circumferential-edge contact surface 141 and the second open-circumferential-edge contact surface 241 are made to come into contact with the open circumferential edge of the PP cap 2. Referring to FIG. 5, the user grips the first gripping part 121 and the second gripping part 221 of the pilfer-proof cap crimping tool 1A with one hand and crimps the open circumferential edge of the PP cap 2 with the pilfer-proof cap crimping tool 1A in such a manner that the first gripping part 121 and the second gripping part 221 come close to each other.

At this time, the lower surface of the lateral wall 246A of the second top plate contact part 243A comes in contact with the top plate 201 of the PP cap 2 through the felt cloth 249A. Unlike the wine bottle 3, the bottle 3A, such as a 720-milliliter-bottle of Japanese sake, does not include a flange 301. However, the lower surface of the lateral wall 246A of the second top plate contact part 243A comes in contact with the top plate 201 of the PP cap 2 through the felt cloth 249A, thereby the first open-circumferential-edge contact surface 141 and the second open-circumferential-edge contact surface 241 are maintained in stable contact with the open circumferential edge of the PP cap 2.

Subsequently, while maintaining the state, the PP cap 2 is rotated relative to the opening part of the bottle 3A of Japanese sake, and the pilfer-proof cap crimping tool 1A is rotated one turn relative to the opening part of the bottle 3A in such a manner that the PP cap 2 is tightened onto the opening part of the bottle 3A. The subsequent operations are the same as those of the first embodiment.

The effects of the pilfer-proof cap crimping tool 1A according to the second embodiment are described below. As described above, the second arm 20A includes a second top plate contact part 243A configured to make contact with a top plate 201 of the PP 2 when at least one of the first open-circumferential-edge contact surface 141 and the second open-circumferential-edge contact surface 241 touches the open circumferential edge of the PP cap 2.

This configuration enables the first open-circumferential-edge contact surface 141 and the second open-circumferential-edge contact surface 241 to maintain a stable contact with the open circumferential edge of the PP cap 2 even when the PP cap 2 is to be crimped and fixed to the opening part of the bottle 3A, such as a 720-milliliter-bottle of Japanese sake, which does not include the flange 301 unlike a wine bottle, since the lower surface of the lateral wall 246A of the second top plate contact part 243A that forms the top plate contact part comes into contact with the top plate 201 of the PP cap 2 through the felt cloth 249A.

The present invention is not limited to the above embodiments, and modifications are possible within the technical scope of the claims. For example, although the second top plate contact part 243A comes in contact with the top plate 201 of the PP cap 2 in the above embodiment, the top plate contact part is not limited thereto. The first top plate contact part 143A and the second top plate contact part 243A may come into contact with the top plate 201 of the PP cap 2, for example.

Each of the first arm 10 and the second arm 20 is made of brass in the above embodiment, but the material thereof is not limited thereto. The first arm 10 and the second arm 20 may be made of stainless steel in view of performing a sterilization procedure and the like.

The configuration and the shape of each component of the pilfer-proof cap crimping tool are not limited to those in the above embodiments. For example, the shape of the first arm 10A near the another end 12 and the shape of the second arm 20A near the another end 22 according to the second embodiment may be employed as the shape of the first arm 10 near the another end 12 and the shape of the second arm 20 near the another end 22 according to the first embodiment.

### EXPLANATION OF REFERENCE NUMERALS

1 pilfer-proof cap crimping tool
2 pilfer-proof cap (PP cap)
3 bottle
3A bottle
10, 10A first arm
11, 11A, 21, 21A one end
12, 12A, 22, 22A another end
13, 13A first arm connection part
14 first-arm-curved-part
20, 20A second arm
23, 23A second arm connection part
24 second-arm-curved-part
121 first gripping part
141 first open-circumferential-edge contact surface
143A first top plate contact part (top plate contact
part)
221 second gripping part
241 second open-circumferential-edge contact surface
243A second top plate contact part (top plate contact
part)
249A felt cloth (top plate contact part)

1. A pilfer-proof cap crimping tool comprising:
a first arm having one end and another end, and extending from the one end to the another end; and
a second arm having one end and another end, and extending from the one end to the another end, wherein
the one end of the first arm includes a first arm connection part,
the one end of the second arm includes a second arm connection part connected to the first arm connection part of the first arm in a rotatable manner with respect to the first arm, the first arm includes:
a first-anti-curved-part that is curved at a part between the one end and the another end of the first arm to separate it from the second arm; and
a first gripping part that is positioned nearer to the another end of the first arm in comparison with the first-arm-curved-part to be gripped by a hand of a user,
the second aim includes:
a second-arm-curved-part that is curved at a part opposite to the first-arm-curved-part between the one end and the another end of the second arm to separate it from the first arm; and
a second gripping part that is positioned nearer to the another end of the second arm in comparison with the second-arm-curved-part to be gripped by the hand of the user,
the first-arm-curved-part includes a first open-circumferential-edge contact surface that is configured to touch a part of an open circumferential edge of the pilfer-proof cap, the part having a length of 3 mm to 6 mm in a circumferential direction of the open circumferential edge,
the second-arm-curved-part includes a second open-circumferential-edge contact surface that is configured to touch a part of the open circumferential edge of the pilfer-proof cap, the part having a length of 3 mm to 6 mm in the circumferential direction of the open circumferential edge, and
a distance between the first gripping part and the second gripping part is 35 mm to 45 mm, when the first open-circumferential-edge contact surface and the second open-circumferential-edge contact surface touch the open circumferential edge to hold the pilfer-proof cap with the first arm and the second arm.

2. The pilfer-proof cap crimping tool according to claim 1, wherein
when the first open-circumferential-edge contact surface and the second open-circumferential-edge contact surface are in contact with the open circumferential edge, an angle formed by a straight line connecting the first open-circumferential-edge contact surface and the center of the pilfer-proof cap and a straight line connecting the second open-circumferential-edge contact surface and the center of the pilfer-proof cap on a side of the first arm connection part with respect to the center of the pilfer-proof cap is equal to or less than 180°.

3. The pilfer-proof cap crimping tool according to claim 1 or 2, wherein
each of the first arm and the second arm has a circular cross section which is orthogonal to a longitudinal direction of each of the first arm and the second arm, and
the diameter of the cross section is 5.5 mm to 8.0 mm.

4. The pilfer-proof cap crimping tool according to claim 1, wherein
where a circumferential surface of an opening part of a bottle-shaped container to which the pilfer-proof cap is crimped has an external thread, and the external thread includes a flange on a side opposite to an open end of the opening part,
the first-arm-curved-part includes a first flange-contact-surface configured to make contact with the flange when the first open-circumferential-edge contact surface and the second open-circumferential-edge contact surface touch the open circumferential edge of the pilfer-proof cap to hold the pilfer-proof cap with the first aim and the second arm, and
the second-arm-curved-part includes a second flange-contact-surface configured to make contact with the flange when the first open-circumferential-edge contact surface and the second open-circumferential-edge contact surface touch the open circumferential edge of the pilfer-proof cap to hold the pilfer-proof cap with the first arm and the second arm.

5. The pilfer-proof cap crimping tool according to claim 1, wherein
at least one of the first arm and the second arm includes a top plate contact part configured to make contact with a top plate of the pilfer-proof cap when at least one of the first open-circumferential-edge contact surface and the second open-circumferential-edge contact surface touches the open circumferential edge of the pilfer-proof cap.
